(19) United States
(12) Patent Application Publication
(10) Pub. No.: US 2026/0104127 A1
(43) Pub. Date: Apr. 16, 2026

(54) EXPANDABLE INSULATING PACKETS FOR USE AS AN INSULATION MATERIAL WITHIN A VACUUM INSULATED STRUCTURE

(71) Applicant: WHIRLPOOL CORPORATION, BENTON HARBOR, MI (US)

(72) Inventors: José Guizoni, JR., Ypsilanti, MI (US); Sankarshan Verma, Pune (IN)

(73) Assignee: WHIRLPOOL CORPORATION, BENTON HARBOR, MI (US)

(21) Appl. No.: 18/915,700

(22) Filed: Oct. 15, 2024

(51) Int. Cl. F16L 59/065

(52) U.S. Cl. CPC F16L 59/065; F25D 2201/14

(57) ABSTRACT

A vacuum insulated structure includes first and second panels that oppose one another, and a plurality of insulating packets. The first and second panels are coupled to define an insulating cavity therein. Each insulating packet has an interior space that defines a partial vacuum that is maintained at a first internal pressure. The insulating packets are disposed within the insulating cavity. The insulating cavity defines an at least partial vacuum that is maintained at a second internal pressure that is less than the first internal pressure. A pressure differential between the first and second internal pressures causes each insulating packet to enlarge to an expanded state. The expanded state of the insulating packets opposes an inward vacuum force exerted on the first and second panels by the at least partial vacuum of the insulating cavity to prevent wall thickness reduction of the first and second panels.

### BACKGROUND OF THE DISCLOSURE

The present disclosure generally relates to insulation structures for appliances, and more specifically, an insulated structure for an appliance that includes an insulation material having expandable insulating packets that utilize a pressure differential to expand within an insulating cavity as gas is evacuated from the insulating cavity.

### SUMMARY OF THE DISCLOSURE

According to one aspect of the present disclosure, a vacuum insulated structure includes a first panel, a second panel that opposes the first panel, and a plurality of insulating packets. The first panel is coupled with the second panel to define an insulating cavity therein. Each insulating packet of the plurality of insulating packets has an interior space that defines a partial vacuum that is maintained at a first internal pressure. The plurality of insulating packets are disposed within the insulating cavity. The insulating cavity defines an at least partial vacuum that is maintained at a second internal pressure that is less than the first internal pressure. A pressure differential between the first internal pressure of the interior space of each insulating packet and the second internal pressure of the insulating cavity causes each insulating packet to enlarge to an expanded state. The expanded state of the plurality of insulating packets opposes an inward vacuum force exerted on the first panel and the second panel by the at least partial vacuum of the insulating cavity to prevent reduction in wall thickness of the insulating cavity between the first panel and the second panel.

According to another aspect of the present disclosure, a vacuum insulated structure includes an insulating envelope that defines an insulating cavity therein and an insulating material that includes a plurality of insulating packets disposed within the insulating cavity. Each insulating packet of the plurality of insulating packets includes an outer wall with an interior space defined within the outer wall. The interior space defines a partial vacuum that is maintained at a first internal pressure. The insulating cavity defines an at least partial vacuum that is maintained at a second internal pressure. The second internal pressure is less than the first internal pressure. A pressure differential between the first internal pressure and the second internal pressure causes the plurality of insulating packets to define an expanded state within the insulating cavity. The expanded state of the plurality of insulating packets generates an outward expansion force that opposes an inward vacuum force exerted by the at least partial vacuum of the insulating cavity. The outward expansion force and the inward vacuum force are in a counterbalanced state that prevents reduction in wall thickness and maintains the wall thickness of the insulating envelope.

According to yet another aspect of the present disclosure, a method for forming an insulating appliance cabinet includes steps of placing a plurality of insulating packets into an insulating cavity of an insulated structure where the plurality of insulating packets has an interior space that is maintained at a partial vacuum having a first internal pressure, evacuating gas from the insulating cavity to define an at least partial vacuum within the insulating cavity that defines a second internal pressure, creating a pressure differential wherein the second internal pressure is less than the first internal pressure, expanding the plurality of insulating packets due to the pressure differential to define an expanded state of the plurality of insulating packets, and sealing the insulating cavity.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of an appliance that incorporates an aspect of the insulating material having expandable insulating packets disposed therein;

FIG. 2 is a schematic diagram illustrating an aspect of the expandable insulating packets, shown in an expanded state;

FIG. 3 is a schematic diagram illustrating an aspect of the expandable insulating packets changing from a collapsed state to an expanded state during evacuation of gas from an insulating cavity;

FIG. 4(a)-(d) are a series of schematic diagrams illustrating an exemplary process for forming an expandable insulating packet;

FIG. 5(a)-(c) are a series of schematic diagrams illustrating an exemplary process for evacuating an insulating cavity to convert the insulating packets from a collapsed state to an expanded state;

FIG. 6 is a linear flow diagram illustrating a method for forming an insulating appliance cabinet; and

FIG. 7 is a linear flow diagram illustrating a method for forming an insulated structure.

The components in the figures are not necessarily to scale, emphasis instead being placed upon illustrating the principles described herein.

### DETAILED DESCRIPTION

The present illustrated embodiments reside primarily in combinations of method steps and apparatus components related to expandable insulating packets for use as an insulation material within a vacuum insulated structure. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

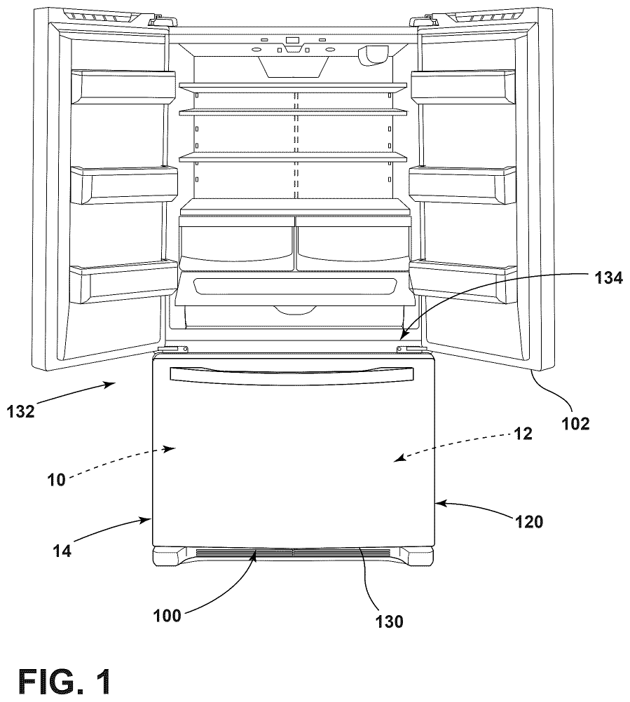

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-5(c), reference numeral 10 generally refers to an insulating material that is disposed within an insulating cavity 12 for a vacuum insulated structure 14. According to various aspects of the device, the vacuum insulated structure 14 includes a first panel 16, and a second panel 18 that opposes the first panel 16. The first panel 16 is coupled with the second panel 18 to define the insulating cavity 12 therein. A plurality of insulating packets 20 are disposed within the insulating cavity 12 to at least partially define the insulating material 10. Each insulating packet 20 of the plurality of insulating packets 20 includes an interior space 22 that defines a partial vacuum 24. This partial vacuum 24 is maintained at a first internal pressure 26. Gas 28 within the insulating cavity 12 is evacuated to define an at least partial vacuum 30. This at least partial vacuum 30 is maintained at a second internal pressure 32, the second internal pressure 32 being less than the first internal pressure 26 present within each of the interior spaces 22 of the insulating packets 20. A pressure differential 34 is formed between the first internal pressure 26 of the interior space 22 for each insulating packet 20 and the second internal pressure 32 of the insulating cavity 12. This pressure differential 34 causes each insulating packet 20 to expand from a collapsed state 36 to an expanded state 38. The expanded state 38 of the insulating packets 20 generates an outward expansion force 40 that pushes against, directly or indirectly, an interior surface 42 of the first panel 16 and the second panel 18. As gas 28 is further evacuated from the insulating cavity 12, the at least partial vacuum 30 formed therein causes an inward vacuum force 44 that is also exerted on the first panel 16 and second panel 18. Typically, this inward vacuum force 44 can result in a local reduction in wall thickness 60 of the insulated structure 14 that is commonly referred to as a vacuum bow. Using the insulating material 10 having the insulating packets 20, the outward expansion force 40 exerted by the insulating packets 20 in the expanded state 38 counteracts the inward vacuum force 44 and prevents the local reduction in wall thickness 60 of the insulating cavity 12 of the first panel 16 and second panel 18. As discussed herein, the reduction in wall thickness 60 can be caused by the first panel 16 and the second panel 18 deflecting toward one another as a result of the inward vacuum force 44. The evacuation of gas from the insulating cavity 12 can be accomplished through any number of mechanisms and processes that include, but are not limited to, an air pump, expressing gas from the insulating cavity 12, and other similar methods and mechanisms.

Referring again to FIGS. 1-5(c), the insulating packets 20, when kept at atmosphere (approx. 1000 mbar), define the collapsed state 36. In this collapsed state 36, a minimal amount of gas 28 or air is contained within the interior space 22 of each insulating packet 20. This minimal amount of air creates the first internal pressure 26 as a low-pressure space that collapses when exposed to atmosphere. The first internal pressure 26 of the interior space 22 of each insulating packet 20 can be generally within a range of from approximately 0.1 mbar to approximately 15 mbar. It is also contemplated that the first internal pressure 26 of the interior space 22 of each insulating packet 20 can be generally within a range of from approximately 0.1 mbar to approximately 1000 mbar.

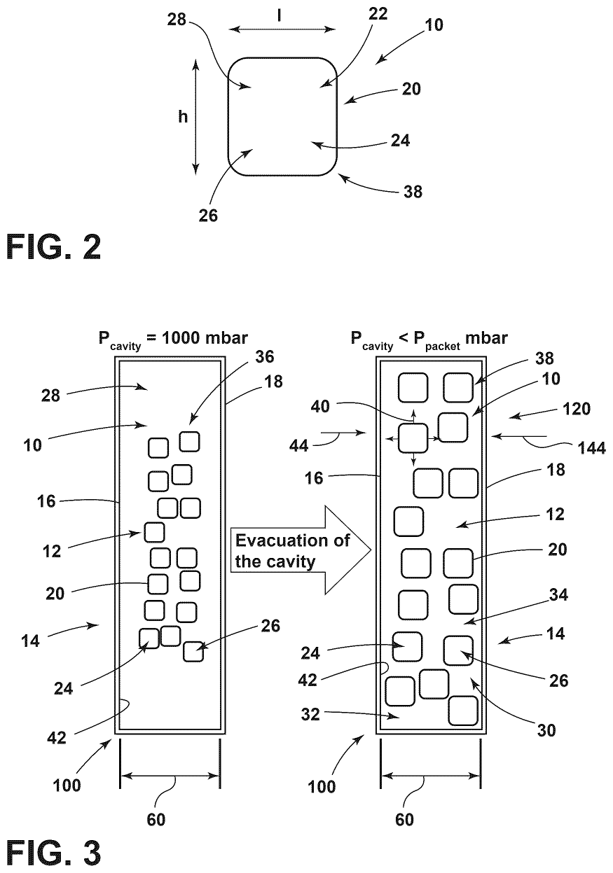

As exemplified in FIGS. 2-3 and 5, these insulating packets 20 can be disposed within the insulating cavity 12 of the insulated structure 14. These insulating packets 20 can be disposed within the insulating cavity 12 such that the insulating packets 20 fill or excessively fill the insulating cavity 12. During manufacture of the insulating cavity 12, gas 28 is evacuated from the insulating cavity 12 to define the at least partial vacuum 30 that assists in preventing thermal transmission of heat through the vacuum insulated structure 14. As gas 28 is evacuated from the insulating cavity 12, the second internal pressure 32 decreases. When the second internal pressure 32 decreases to the point where the second internal pressure 32 is below the first internal pressure 26 defined within the interior space 22 of the various insulating packets 20, the pressure differential 34 between the first internal pressure 26 and the second internal pressure 32 is formed. This pressure differential 34 causes the insulating packets 20 to enlarge, expand, or otherwise grow to the expanded state 38. As the pressure differential 34 between the first internal pressure 26 and the second internal pressure 32 becomes greater, the insulating packets 20 can continue to expand to an increased size of the expanded state 38. While the insulating packets 20 are schematically shown as being generally rectangular, the insulating packets 20 in the expanded state 38 typically take on a generally spherical or rounded shape due to a homogenous application of the outward expansion force 40.

As described herein, in this expanded state 38, insulating packets 20 define the outward expansion force 40 that outwardly biases the first panel 16 and the second panel 18 of the insulated structure 14. Again, this outward expansion force 40 counteracts the inward vacuum force 44 exerted as a result of the evacuation of gas 28 from the insulating cavity 12. This outward expansion force 40 and the inward vacuum force 44 generally counterbalance one another such that the vacuum insulated structure 14 maintains a consistent wall thickness 60 during the evacuation process. Accordingly, the wall thickness 60 of the vacuum insulated structure 14 is nearly the same before the evacuation process begins as compared with after the evacuation process is complete.

According to various aspects of the device, the insulating material 10 can be disposed within the insulating cavity 12 such that the amount of insulating material 10 causes a slight outward bow or deflection of the first panel 16 and second panel 18 of the vacuum insulated structure 14. This overfilling of the insulating cavity 12 can operate to slightly enlarge the wall thickness 60 of the vacuum insulated structure 14. During the evacuation process, it is contemplated that the inward vacuum force 44 may be slightly greater than the outward expansion force 40 generated by the insulating packets 20 transitioning to the expanded state 38. In such an aspect of the device, the outward bow or deflection of the insulated structure 14 experienced before the evacuation process begins can assist in counteracting the inward vacuum force 44. Accordingly, when the evacuation process is complete and the desired second internal pressure 32 is reached, the wall thickness 60 of the vacuum insulated structure 14 reaches the desired dimension.

Referring now to FIGS. 2-5, in certain aspects of the device, the plurality of insulating packets 20 can be mixed with a secondary insulator 70 to define the insulating material 10 as a composite material. It is contemplated that the secondary insulator 70 can be any one of various insulating materials 10. Typically, these materials can include fumed silica, precipitated silica, other similar silica-based materials, perlite, opacifiers, combinations thereof, and other similar insulating substances. Where the insulating material 10 is formed by the insulating packets 20 and the secondary insulator 70, the insulating packets 20 and the secondary insulator 70 can be premixed such that the insulating packets 20 are dispersed, typically evenly dispersed, within the secondary insulator 70, and vice versa. When this composite insulating material 10 is disposed within the insulating cavity 12, the insulating packets 20 are distributed throughout the insulating cavity 12.

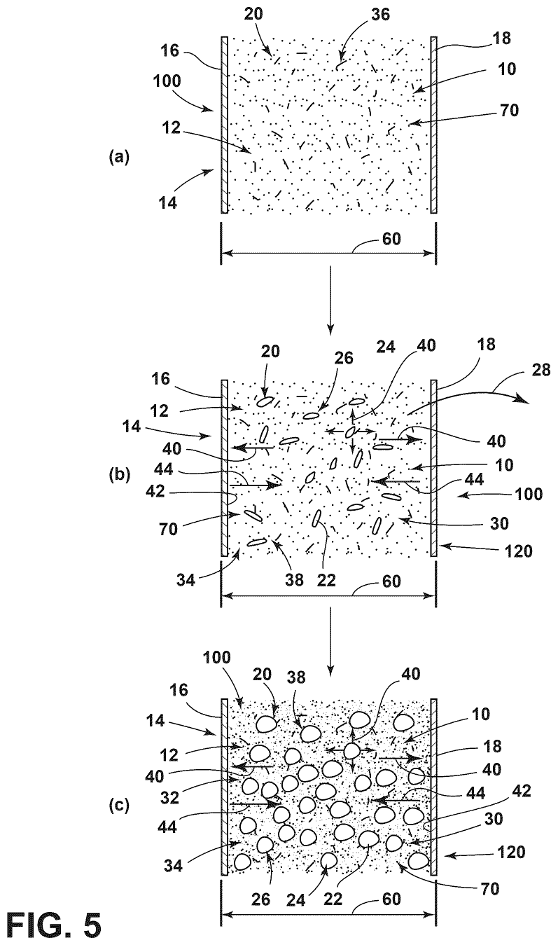

As exemplified in FIG. 5(a)-5(c), during the evacuation process, where gas 28 is evacuated from the insulating cavity 12, the insulating packets 20 transition from the collapsed state 36 (FIG. 5(a)) to the expanded state 38 (FIG. 5(c)). As the insulating packets 20 transition to the expanded state 38 (illustrated in FIG. 5(b)), the insulating packets 20 in the expanded state 38 occupy greater amounts of space. As these insulating packets 20 expand to occupy greater amounts of space, the secondary insulator 70 occupies less space within the insulating cavity 12. In this manner, the secondary insulator 70, and the insulating material 10, as a whole, can densify due to the diminishing amount of space available for the secondary insulator 70 caused by the expansion of the insulating packets 20 to the expanded state 38. This is in combination with the effect of the inward vacuum force 44 exerted by the first panel 16 and the second panel 18 toward one another due to the evacuation of gas 28 from the insulating cavity 12. Additionally, through this configuration, the densification of the insulating material 10 due to the expansion of the insulating packets 20 to the expanded state 38 can provide a more robust interior structure that assists in preventing local reduction in wall thickness 60 during the evacuation process. Accordingly, the secondary insulator 70 becomes highly compressed, from the exterior, due to the inward vacuum force 44 exerted by the first panel 16 and the second panel 18. The secondary insulator 70 is also compressed, from the interior or internally, by the expansion of the insulating packets 20 to the expanded state 38 and the outward expansion force 40 resulting therefrom.

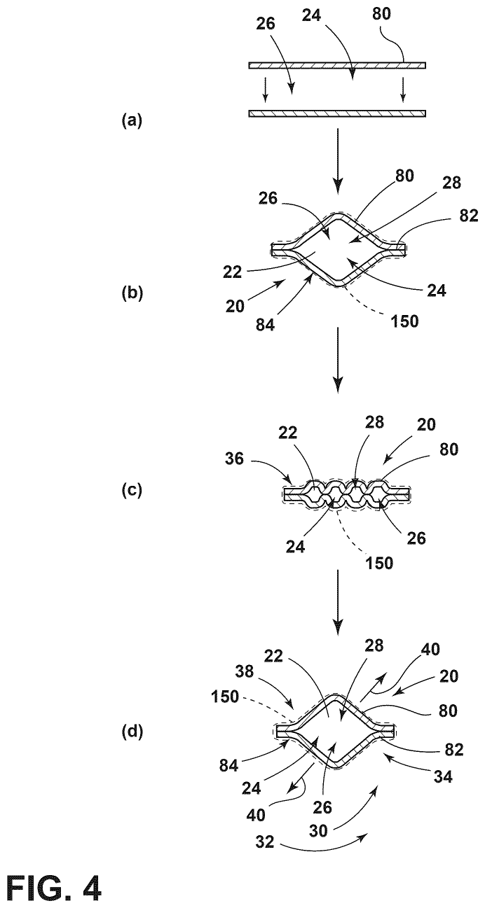

According to the various aspects of the device, the insulating packets 20 can be formed in any number of processes. In an exemplary process, as exemplified in FIG. 4(a) - 4(d), opposing sheets 80 are attached together to define a seal 82 where the interior space 22 is defined between the opposing sheets 80 (FIG. 4(a)). The opposing sheets 80 can be held together by adhesion, welding, or other similar process (FIG. 4(b)). Typically, the insulating packets 20 are defined by an outer wall 84 that is made of the opposing sheets 80 of a polymeric material. This polymeric material can include, but is not limited to, polypropylene, polystyrene, and other similar polymers that are flexible and also can maintain a vacuum or partial vacuum within the interior space 22 of the insulating packets 20.

It is also contemplated that the insulating packets 20 can be formed as a single sheet 80 of the polymeric material that is formed to encircle a space that defines the same air pressure as the desired first internal pressure 26 found within the interior space 22 of the insulating packets 20. In these various processes for manufacturing the insulating packets 20, the outer wall 84 of the insulating packet 20 is formed around a depressurized section of space that defines the first internal pressure 26 that is desired within the interior space 22 of the insulating packets 20. When sealed, these insulating packets 20, whether made of a single sheet 80 or multiple sheets 80, can be exposed to atmosphere. When exposed to atmosphere, the insulating packets 20 will contract to define the collapsed state 36 (FIG. 4(c)). These insulating packets 20 in the collapsed state 36 are then disposed within an insulating cavity 12. When gas 28 is evacuated from the insulating cavity 12 to define the second internal pressure 32, the insulating packets 20 expand from the collapsed state 36 to the expanded state 38, as described herein (FIG. 4(d)). Typically, the insulating packets 20 in the expanded state 38 include a primary dimension or larger dimension of approximately 0.5 μm to approximately 20 μm. It is contemplated that other sizes of the insulating packets 20 can be achieved and used within the insulating cavity 12.

According to various aspects of the device, as exemplified in FIGS. 1-5(c), the vacuum insulated structure 14 includes an insulating envelope 100 that defines an insulating cavity 12 therein. This insulating envelope 100 can be formed by the first panel 16 and the second panel 18 that are attached together, typically via a trim breaker 102 or other connecting member that allows the insulating envelope 100 to form the insulating cavity 12 therein. The insulating material 10 is disposed within the insulating cavity 12. This insulating material 10 includes the insulating packets 20 that are disposed within the insulating cavity 12. As described herein, the insulating material 10 can also include the secondary insulator 70 that is combined with the insulating packets 20 to form a composite form of the insulating material 10. Each insulating packet 20 of the plurality of insulating packets 20 includes the outer wall 84 with the interior space 22 defined within this outer wall 84. As described herein, the interior space 22 defines the partial vacuum 24 that is maintained at the first internal pressure 26. The insulating cavity 12 defines the at least partial vacuum 30 that is maintained at the second internal pressure 32. The second internal pressure 32 is less than the first internal pressure 26 to define the pressure differential 34. This pressure differential 34 between the first internal pressure 26 and the second internal pressure 32 causes the plurality of insulating packets 20 to expand and define the expanded state 38 within the insulating cavity 12. In this expanded state 38, the plurality of insulating packets 20 generates the outward expansion force 40 that opposes the inward vacuum force 44. This inward vacuum force 44 is exerted by the effect of the at least partial vacuum 30 of the insulating cavity 12. As described herein, the outward expansion force 40 and the inward vacuum force 44 are in a counterbalanced state 120. In this counterbalanced state 120, the insulating envelope 100 does not experience cavitation such that the counterbalanced state 120 prevents local reduction in wall thickness 60 and maintains the wall thickness 60 of the insulating envelope 100.

As exemplified in FIGS. 1-5(c), the insulating envelope 100 that includes the insulating packets 20 can be used to form a door panel 130 for an appliance 132, a structural cabinet 134 for an appliance 132, insulating panels that can be disposed within a structural cabinet 134, and other similar structures that can be utilized as part of a vacuum insulated structure 14 for an appliance 132, fixture, or other similar application.

According to the various aspects of the device, the sheet or sheets 80 that form the insulating packets 20 is typically made of a polymer material, as described herein. To increase the ability of each of the insulating packets 20 to prevent gas 28 permeation through the outer wall 84, the outer wall 84 of each insulating packet 20 can include a coating 150 that enhances the resistance to gas permeation for each insulating packet 20. These coatings 150 can form a single barrier layer, or multiple barrier layers, that extend around each insulating packet 20 to maintain resistance to gas permeation. By preventing gas permeation, the insulating packets 20 can be maintained in the expanded state 38 within the insulating cavity 12 for an extended period of time. The coating 150 can also provide an increased resistance to thermal transmission through and around the outer wall 84 of each insulating packet 20. In this manner, the coatings 150 can interrupt or otherwise disrupt the path of heat to prevent thermal transmission through the insulating material 10.

Referring again to FIGS. 1-5(c), when gas 28 is evacuated from the insulating cavity 12 during manufacture of the appliance 132, the insulating cavity 12 of the insulating envelope 100 is depressurized to define the second internal pressure 32. This second internal pressure 32 is less than the first internal pressure 26, and is typically within a range of from approximately 0.05 mbar to approximately 5 mbar. As discussed herein, the second internal pressure 32 is designed to be less than the first internal pressure 26 of the interior space 22 of the insulating packets 20 to define the pressure differential 34. Again, the pressure differential 34 results in the transition of the insulating packets 20 from the collapsed state 36 to the expanded state 38.

According to the various aspects of the device, during manufacture of the various insulating packets 20, it is contemplated that the outer wall 84 of the insulating packets 20 may tend to stick to itself due to the depressurized nature of the interior space 22 maintained at the first internal pressure 26. To prevent this self-sticking phenomenon, it is contemplated that a small amount of a spacing material or other similar material that is smaller than the interior space 22 can be disposed within the interior space 22 to prevent this sticking phenomenon from occurring.

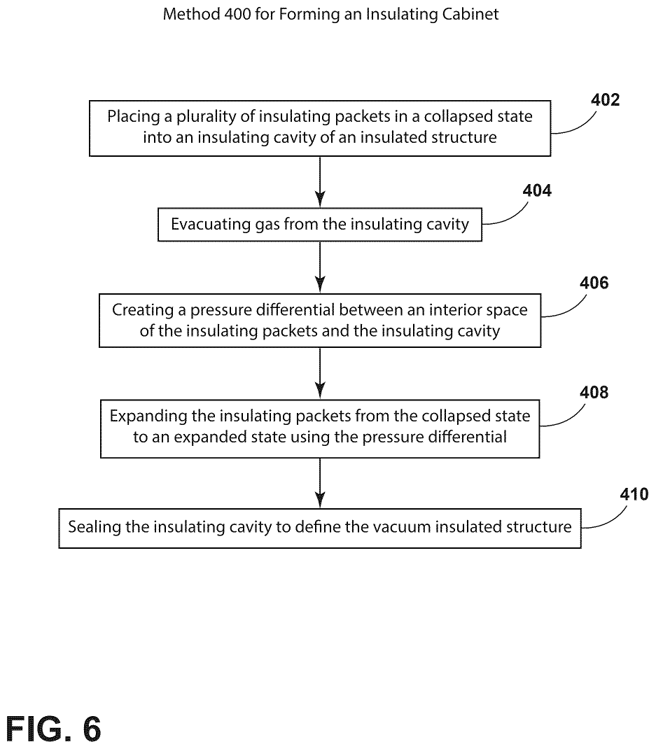

Referring now to FIGS. 1-6, having described various aspects of the insulating material 10 that includes the insulating packets 20, a method 400 is disclosed for forming an insulating appliance cabinet. According to the method 400, a step 402 includes placing a plurality insulating packets 20 in the collapsed state 26 into the insulating cavity 12 of the insulated structure 14. As described herein, the insulating packets 20 include the interior space 22 that is maintained at the partial vacuum 24 having the first internal pressure 26. Once disposed within the insulating cavity 12, gas 28 is evacuated from the insulating cavity 12 to define at least partial vacuum 30 within the insulating cavity 12 that defines the second internal pressure 32 (step 404). As described herein, the second internal pressure 32 persists within the insulating cavity 12, and around the outer walls 84 of each of the insulating packets 20. Accordingly, the pressure differential 34 is created where the second internal pressure 32 is less than the first internal pressure 26 (step 406). Because of this pressure differential 34, the insulating packets 20 are expanded to define an expanded state 38 (step 408). As described herein, in transitioning to the expanded state 38 due to the pressure differential 34, the insulating packets 20 occupy greater amounts of space that cause the outward expansion force 40. This outward expansion force 40 counteracts the inward vacuum force 44 generated due to the evacuation of gas 28 from within the insulating cavity 12. This outward expansion force 40 and inward vacuum force 44 counterbalance one another, or substantially counterbalance one another, to maintain a wall thickness 60 of the insulating envelope 100 to be a consistent thickness during the evacuation process and after the evacuation process is completed. Once the evacuation process is complete, the insulating cavity 12 is sealed to define the vacuum insulated structure 14 (step 410).

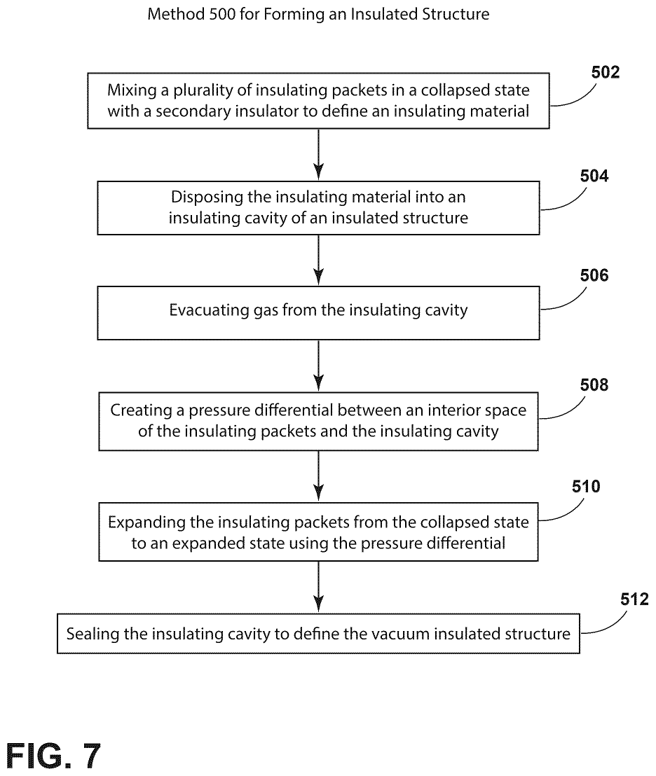

Referring now to FIGS. 1-5(c) and 7, having described various aspects of the insulating material 10 having the insulating packets 20, a method 500 is disclosed for forming an insulated structure 14. According to the method 500, a step 502 includes mixing a plurality of insulating packets 20 in the collapsed state 36 with a secondary insulator 70 to form an insulating material 10. Once mixed, the insulating material 10 having the secondary insulator 70 and the insulating packets 20 is disposed into the insulating cavity 12 (step 504). Once placed in the insulating cavity 12, gas 28 is evacuated from the insulating cavity 12 to define the at least partial vacuum 30 within the insulating cavity 12 that defines the second internal pressure 32 (step 506). This evacuation of gas 28 creates the pressure differential 34 wherein the second internal pressure 32 is less than the first internal pressure 26 (step 508). The insulating packets 20, due to the pressure differential 34, expand to define the expanded state 38 of the insulating packets 20 (step 510). Once the pressure differential 34 is formed and the insulating packets 20 transition to the expanded state 38, the insulating cavity 12 is sealed to define the vacuum insulated structure 14 (step 512).

According to the various aspects of the device, insulating packets 20 are manufactured as closed hollow particles with a range of air pressures within the interior space 22. This range of air pressures can vary from a normal or atmospheric air pressure to an exceptionally low air pressure that is contained within the interior space 22 of the insulating packet 20. The outer wall 84 of each insulating packet 20 is hermetically sealed either through the formation of a single polymeric sheet 80 or multiple polymeric sheets 80, typically two opposing polymeric sheets 80, that are sealed together. Through this configuration, the insulating packets 20 are formed with a low permeability to gas 28 and low outgassing on all sides of the outer wall 84. Additionally, the dimensions of each insulating packet 20 are maintained as low as possible, as described herein. This allows a large number of these insulating packets 20 to be disposed within the insulating cavity 12 for the insulating envelope 100. Typically, to the naked eye, the insulating packets 20 will appear as powder when disposed within the insulating cavity 12. The insulating packets 20 also behave as a powder in terms of flowability and other characteristics. The small particle size of the insulating packets 20 also results in a lower thermal conductivity of the material that makes up the insulating packets 20. Accordingly, this small size of the insulating packets 20 results in a more effective thermal insulation material that resists thermal transmission of heat through the insulating cavity 12 over an extended period of time.

According to the various aspects of the device, the amount of expansion that each insulating packet 20 experiences in transitioning to the expanded state 38 of each insulating packet 20 can depend upon the sheet material that is used for the insulating packets 20. It is contemplated that the material of the outer wall 84 can be elastic in nature. In this manner, the transition of the insulating packet 20 to the expanded state 38 can include an elastic expansion of the outer wall 84. It is also contemplated that the material of the outer wall 84 can be less elastic or even inelastic. In such an aspect of the device, the transition of the insulating packets 20 from the collapsed state 36 to the expanded state 38 can involve an expansion of wrinkles, pleats, folds, or other geometries that may exist in the insulating packets 20 in the collapsed state 36.

Additionally, these insulating packets 20, which can be described as vacuum activated inflatable balls, can expand to exert the positive outward expansion force 40 on the first and second panels 16, 18 of the insulating envelope 100. As described herein, this outward expansion force 40 is helpful to balance the opposite forces due to atmospheric pressure, which are characterized herein as the inward vacuum force 44. This inward vacuum force 44 can also be described as the compressive force of atmosphere acting upon the outer surface of the insulating envelope 100 due to a pressure differential 34 between the atmosphere outside of the insulated structure 14 and the second internal pressure 32 of the insulating cavity 12. Use of the insulating packets 20 in the expanded state 38 generates the outward expansion force 40 that counterbalances the pressure effects caused by the evacuation of gas 28 from the insulating cavity 12 of the insulating envelope 100. This configuration assists in improving the resistance to local reduction in wall thickness 60 during the manufacture of vacuum insulated structures 14.

Additionally, the insulating packets 20 in the expanded state 38 contain a range of air pressures. These air pressures can range from a normal or atmospheric air pressure to an exceptionally low pressure caused by very minimal amounts of gas 28, air, or other insulating gases contained within the interior space 22 of the insulating packet 20. These insulating gasses can include, but are not limited to, carbon dioxide, xenon, krypton, argon, cyclopentane, hydrofluoroolefin, and other similar insulating gasses. This minimal amount of trapped insulating gas defines a minimal thermal conductivity. The main path of thermal conductivity through the insulating material 10 may be through the polymer sheets 80 that form the insulating packets 20. As described herein, certain coatings can be applied to the outer surface of the insulating packets 20 to reduce thermal conductivity across the various insulating packets 20 contained within the insulating material 10.

According to the various aspects of the device, the insulating material 10 that includes the insulating packets 20 that can transition to the expanded state 38 in a vacuum setting can be utilized within any number of appliances 132. Such appliances 132 can include, but are not limited to, refrigerating appliances, freezing appliances, appliances that include an insulating layer, such as dishwashers, laundry appliances, countertop appliances, ovens, and other similar insulating structures. As described herein, the insulating material 10 can be utilized within an insulating panel that may be disposed within a separate insulating appliance 132.

Utilizing the insulating packets 20 having the interior space 22 that is maintained at the first internal pressure 26, evacuation of gas 28 from the insulated structure 14 can be accomplished in the absence of local reduction of the wall thickness 60. As the insulating packets 20 expand or enlarge to the expanded state 38, the insulating packets 20 generate an outward expansion force 40 that opposes the inward vacuum force 44 generated as a result of the evacuation of gas 28 from the insulating cavity 12. The outward expansion force 40 and the inward vacuum force 44 counterbalance one another to maintain the wall thickness 60 of the insulating cavity 12 to be consistent throughout the evacuation process and after the evacuation process is complete. As described herein, expansion of the insulating packets 20 to the expanded state 38 can result in the densification of the secondary insulator 70 that is intermixed with the insulating packets 20. This densification of the secondary insulator 70 of the insulating material 10 can result in a robust structure that prevents local reduction of the wall thickness 60 of the insulating envelope 100 during formation of the vacuum insulated structure 14.

According to one aspect of the present disclosure, a vacuum insulated structure includes a first panel, a second panel that opposes the first panel, and a plurality of insulating packets. The first panel is coupled with the second panel to define an insulating cavity therein. Each insulating packet of the plurality of insulating packets has an interior space that defines a partial vacuum that is maintained at a first internal pressure. The plurality of insulating packets are disposed within the insulating cavity. The insulating cavity defines an at least partial vacuum that is maintained at a second internal pressure that is less than the first internal pressure. A pressure differential between the first internal pressure of the interior space of each insulating packet and the second internal pressure of the insulating cavity causes each insulating packet to enlarge to an expanded state. The expanded state of the plurality of insulating packets opposes an inward vacuum force exerted on the first panel and the second panel by the at least partial vacuum of the insulating cavity to prevent local reduction of a wall thickness of the insulating cavity between the first panel and the second panel.

According to another aspect, the plurality of insulating packets is mixed with a secondary insulator to define an insulating material.

According to another aspect, the secondary insulator is at least one of a silica-based material and perlite.

According to another aspect, the first panel and the second panel form a door panel.

According to another aspect, each insulating packet of the plurality of insulating packets includes opposing polymeric sheets that are sealed together to form the interior space.

According to another aspect, the plurality of insulating packets are formed within the partial vacuum to define the first internal pressure of the interior space of each insulating packet.

According to another aspect, the first internal pressure is from approximately 0.1 mbar to approximately 1000 mbar.

According to another aspect, each insulating packet in the expanded state has a primary dimension of from approximately 0.5 micrometers to approximately 20 micrometers.

According to another aspect of the present disclosure, a vacuum insulated structure includes an insulating envelope that defines an insulating cavity therein and an insulating material that includes a plurality of insulating packets disposed within the insulating cavity. Each insulating packet of the plurality of insulating packets includes an outer wall with an interior space defined within the outer wall. The interior space defines a partial vacuum that is maintained at a first internal pressure. The insulating cavity defines an at least partial vacuum that is maintained at a second internal pressure. The second internal pressure is less than the first internal pressure. A pressure differential between the first internal pressure and the second internal pressure causes the plurality of insulating packets to define an expanded state within the insulating cavity. The expanded state of the plurality of insulating packets generates an outward expansion force that opposes an inward vacuum force exerted by the at least partial vacuum of the insulating cavity. The outward expansion force and the inward vacuum force are in a counterbalanced state that prevents wall thickness reduction and maintains the wall thickness of the insulating envelope.

According to another aspect, the insulating material also includes a secondary insulator that is mixed with the plurality of insulating packets.

According to another aspect, the secondary insulator includes at least one of a silica-based material and perlite.

According to another aspect, the insulating envelope forms an appliance door panel.

According to another aspect, the outer wall of each insulating packet of the plurality of insulating packets includes a polymeric material that encloses the interior space.

According to another aspect, the interior space is partially filled with an insulating gas to define the partial vacuum.

According to another aspect, the insulating gas includes at least one of air and carbon dioxide.

According to another aspect, the plurality of insulating packets are formed within the partial vacuum to define the first internal pressure of the interior space of each insulating packet.

According to another aspect, the first internal pressure is from approximately 0.1 mbar to approximately 15 mbar.

According to another aspect, each insulating packet in the expanded state has a primary dimension of from approximately 0.5 micrometers to approximately 20 micrometers.

According to yet another aspect of the present disclosure, a method for forming an insulating appliance cabinet includes steps of placing a plurality of insulating packets into an insulating cavity of an insulated structure where the plurality of insulating packets has an interior space that is maintained at a partial vacuum having a first internal pressure, evacuating gas from the insulating cavity to define an at least partial vacuum within the insulating cavity that defines a second internal pressure, creating a pressure differential wherein the second internal pressure is less than the first internal pressure, expanding the plurality of insulating packets due to the pressure differential to define an expanded state of the plurality of insulating packets, and sealing the insulating cavity.

According to another aspect, the step of placing the plurality of insulating packets into the insulating cavity of the insulated structure includes mixing the plurality of insulating packets with a secondary insulator and disposing the secondary insulator into the insulating cavity with the plurality of insulating packets.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A vacuum insulated structure comprising:
a first panel;
a second panel that opposes the first panel, wherein the first panel is coupled with the second panel to define an insulating cavity therein; and
a plurality of insulating packets, each insulating packet of the plurality of insulating packets having an interior space that defines a partial vacuum that is maintained at a first internal pressure, the plurality of insulating packets disposed within the insulating cavity, wherein
the insulating cavity defines an at least partial vacuum that is maintained at a second internal pressure that is less than the first internal pressure;
a pressure differential between the first internal pressure of the interior space of each insulating packet and the second internal pressure of the insulating cavity causes each insulating packet to enlarge to an expanded state; and
the expanded state of the plurality of insulating packets opposes an inward vacuum force exerted on the first panel and the second panel by the at least partial vacuum of the insulating cavity to prevent wall thickness reduction of the insulating cavity defined between the first panel and the second panel.

2. The vacuum insulated structure of claim 1, wherein the plurality of insulating packets is mixed with a secondary insulator to define an insulating material.

3. The vacuum insulated structure of claim 2, wherein the secondary insulator is at least one of a silica-based material and perlite.

4. The vacuum insulated structure of claim 1, wherein the first panel and the second panel form a door panel.

5. The vacuum insulated structure of claim 1, wherein each insulating packet of the plurality of insulating packets includes opposing polymeric sheets that are sealed together to form the interior space.

6. The vacuum insulated structure of claim 1, wherein the plurality of insulating packets are formed within the partial vacuum to define the first internal pressure of the interior space of each insulating packet.

7. The vacuum insulated structure of claim 1, wherein the first internal pressure is from approximately 0.1 mbar to approximately 15 mbar.

8. The vacuum insulated structure of claim 1, wherein each insulating packet in the expanded state has a primary dimension of from approximately 0.5 micrometers to approximately 20 micrometers.

9. A vacuum insulated structure comprising:
an insulating envelope that defines an insulating cavity therein; and
an insulating material that includes a plurality of insulating packets disposed within the insulating cavity, each insulating packet of the plurality of insulating packets comprising an outer wall with an interior space defined within the outer wall, the interior space defining a partial vacuum that is maintained at a first internal pressure, wherein
the insulating cavity defines an at least partial vacuum that is maintained at a second internal pressure, the second internal pressure being less than the first internal pressure;
a pressure differential between the first internal pressure and the second internal pressure causes the plurality of insulating packets to define an expanded state within the insulating cavity; and
the expanded state of the plurality of insulating packets generates an outward expansion force that opposes an inward vacuum force exerted by the at least partial vacuum of the insulating cavity, wherein the outward expansion force and the inward vacuum force are in a counterbalanced state that prevents wall thickness reduction and maintains the wall thickness of the insulating envelope.

10. The vacuum insulated structure of claim 9, wherein the insulating material also includes a secondary insulator that is mixed with the plurality of insulating packets.

11. The vacuum insulated structure of claim 10, wherein the secondary insulator includes at least one of a silica-based material and perlite.

12. The vacuum insulated structure of claim 9, wherein the insulating envelope forms an appliance door panel.

13. The vacuum insulated structure of claim 9, wherein the outer wall of each insulating packet of the plurality of insulating packets includes a polymeric material that encloses the interior space.

14. The vacuum insulated structure of claim 9, wherein the interior space is partially filled with an insulating gas to define the partial vacuum.

15. The vacuum insulated structure of claim 14, wherein the insulating gas includes at least one of air and carbon dioxide.

16. The vacuum insulated structure of claim 9, wherein the plurality of insulating packets are formed within the partial vacuum to define the first internal pressure of the interior space of each insulating packet.

17. The vacuum insulated structure of claim 9, wherein the first internal pressure is from approximately 0.1 mbar to approximately 15 mbar.

18. The vacuum insulated structure of claim 9, wherein each insulating packet in the expanded state has a primary dimension of from approximately 0.5 micrometers to approximately 20 micrometers.

19. A method for forming an insulating appliance cabinet, the method comprising steps of:
placing a plurality of insulating packets into an insulating cavity of an insulated structure, the plurality of insulating packets having an interior space that is maintained at a partial vacuum having a first internal pressure;
evacuating gas from the insulating cavity to define an at least partial vacuum within the insulating cavity that defines a second internal pressure;
creating a pressure differential wherein the second internal pressure is less than the first internal pressure;
expanding the plurality of insulating packets due to the pressure differential to define an expanded state of the plurality of insulating packets; and
sealing the insulating cavity.

20. The method of claim 19, wherein the step of placing the plurality of insulating packets into the insulating cavity of the insulated structure includes:
mixing the plurality of insulating packets with a secondary insulator; and
disposing the secondary insulator into the insulating cavity with the plurality of insulating packets.
